(19) United States
(12) Patent Application Publication
(10) Pub. No.: US 2024/0386517 A1
(43) Pub. Date: Nov. 21, 2024

(54) Method for estimating an environmental footprint of a flight of an aircraft and associated electronic estimating system

(71) Applicant: THALES, Meudon (FR)

(72) Inventors: Laurent LALUQUE, MERIGNAC (FR); Guillaume PABIA, MERIGNAC (FR); Pierre-Etienne LEGOUX, MERIGNAC (FR)

(21) Appl. No.: 18/688,780

(22) PCT Filed: Sep. 6, 2022
(86) PCT No.: PCT/EP2022/074745

§ 371 Date: Mar. 3, 2024

(30) Foreign Application Priority Data
Sep. 7, 2021 (FR) 2109364

(51) Int. Cl. G06Q 50/40

(52) U.S. Cl. CPC G06Q 50/40

(57) ABSTRACT

The present invention relates to a method for estimating an environmental footprint of a flight of an aircraft. The method is implemented by a decentralized electronic estimating system including at least a first entity, a second entity and a third entity, the second entity being distinct from the first entity and the third entity. The method includes receipt, by the second entity, from the first entity, at least one datum relative to the aircraft or its environment during the flight. The method also includes association, by the second entity, of a measurement uncertainty with each datum received by the second entity. The method further includes estimation, by the third entity, of an environmental indicator representative of the environmental footprint, on the basis of at least one datum and of the uncertainty associated with the at least one datum.

### CROSS-REFERENCE TO RELATED APPLICATIONS

This application claims benefit under 35 USC § 371 of PCT Application No. PCT/EP2022/074745 entitled METHOD FOR ESTIMATING AN ENVIRONMENTAL FOOTPRINT OF A FLIGHT OF AN AIRCRAFT AND ASSOCIATED ELECTRONIC ESTIMATING SYSTEM, filed on Sep. 6, 2022 by inventors Laurent Laluque, Guillaume Pabia and Pierre-Etienne Legoux. PCT Application No. PCT/EP2022/074745 claims priority of French Patent Application No. 21 09634, filed on Sep. 7, 2021.

### FIELD OF THE INVENTION

The present invention relates to a method for estimating an environmental footprint for a flight of an aircraft.

The invention further relates to a decentralized electronic estimation system suitable for implementing the estimation method.

The invention relates to the field of estimation of the environmental effects of human activity. More particularly, the invention addresses the estimation of the environmental effect of using aircraft for the transportation of people and goods.

### BACKGROUND OF THE INVENTION

Reports estimating the impact of the flight of an aircraft on the environment are known from several governmental and intergovernmental agencies. However, such reports usually focus on a single criterion for the evaluation of the environmental impact associated with aircraft, such as carbon dioxide emissions radiative forcing, or contrails. Thereby, most often, such reports cannot be used for an overall evaluation of the environmental footprint of a flight of an aircraft. Moreover, not all of the reports are consistent with each other. Indeed, some of the reports contradict others, making the evaluation of the environmental footprint of a flight of an aircraft unclear to a reader. Indeed, for the same criterion, some of the reports lead to distinct values making it impossible to reach a consensus on the environmental footprint of an aircraft flight.

There is thus a need to improve the reliability of the estimation of the environmental footprint of the flight of an aircraft.

### SUMMARY OF THE DESCRIPTION

To this end, the subject matter of the present invention is a method for estimating an environmental footprint for a flight of an aircraft, the method being implemented by a decentralized electronic estimation system comprising at least a first entity, a second entity and a third entity, the method comprising:
reception, by the second entity, from the first entity of at least one datum relating to the aircraft or to the environment during the flight,
association, by the second entity, of a measurement uncertainty with each datum received by the second entity,
sending, to the third entity, from the second entity, each datum and the measurement uncertainty associated with such datum, and
estimation by the third entity of an environmental indicator representative of the environmental footprint, based on at least one datum and the uncertainty associated with the at least one datum, the second entity being distinct from the first entity and the third entity.

According to other particular embodiments, the method comprises one or a plurality of the following features, taken individually or according to all technically possible combinations:
each datum received is a measurement coming from a sensor and is chosen from a group comprising:
   a position of the aircraft, and preferentially a position of other vehicles in the environment of the aircraft,
   a datum relating to the weather in the environment of the aircraft, and
   a datum relating to intrinsic features of the aircraft;
the uncertainty associated with each datum received comprises a completeness index representative of a uniformity of the data and an index of confidence in the datum relating to the measurement of the datum;
the completeness index and the confidence index of each datum are determined by the second entity, based on a history of data received from the first entity and from said datum;
a credibility value is associated with the at least one first and second entity (ies), for each first entity, the credibility value being representative of a consistency of the data issued by that first entity with respect to the other first entities, and for each second entity, the credibility value being representative of an objectivity in the association of measurement uncertainty with each datum;
the decentralized electronic estimation system comprises at least two second entities, and wherein if the credibility value of one of the second entities is lower than a predefined credibility threshold, said second entity is excluded from the decentralized electronic estimation system;
the environmental indicator is chosen from a group comprising:
   a quantity of carbon dioxide emitted,
   a quantity of carbon dioxide equivalent,
   a radiative forcing,
   a potential of global warming, and
   a change in temperature over a predetermined period of time;
the decentralized electronic estimation system comprises at least two second entities, and wherein the association step comprises the following sub-steps:
   assignment, to the datum and by each second entity, of a measurement uncertainty score of said datum, each measurement uncertainty score being specific to said second entity,
   determination of the measurement uncertainty of the datum from the measurement uncertainty scores assigned by the second entities, and
   allocation, to the datum received, of the determined measurement uncertainty;
the decentralized electronic estimation system comprises at least two second entities, and wherein the method further comprises, after the step of estimation of the environmental indicator, a second association step comprising the following sub-steps:
   assignment of an estimation uncertainty score to the environmental indicator by each second entity, each estimation uncertainty score being specific to said second entity,
   determination of an estimation uncertainty of the environmental indicator from the estimation uncertainty scores assigned by each second entity, and
   assignment to the environmental indicator, of the estimation uncertainty determined.

The present invention further relates to a decentralized electronic estimation system comprising a first entity, a second entity and a third entity.

the second entity being configured to receive, from the first entity, at least one datum relating to the aircraft or to the environment thereof during the flight,
the second entity being configured to associate a measurement uncertainty with each datum received by the second entity, the second entity being configured to send each datum and measurement uncertainty associated with said datum to the third entity, and the third entity being configured to estimate an environmental indicator representative of the environmental footprint, based on at least one datum and the uncertainty associated with the at least one datum, the second entity being distinct from the first entity and from the third entity.

### BRIEF DESCRIPTION OF THE DRAWINGS

Other features and advantages of the invention will appear upon reading the following description which follows, of the embodiments of the invention, given only as a limiting example, and making reference to the enclosed drawings, wherein:

FIG. 1 is a partial schematic representation of a decentralized electronic system of estimation according to the invention, and

FIG. 2 is a flowchart of an example of implementation of a method of estimation according to the invention.

### DETAILED DESCRIPTION OF EMBODIMENTS

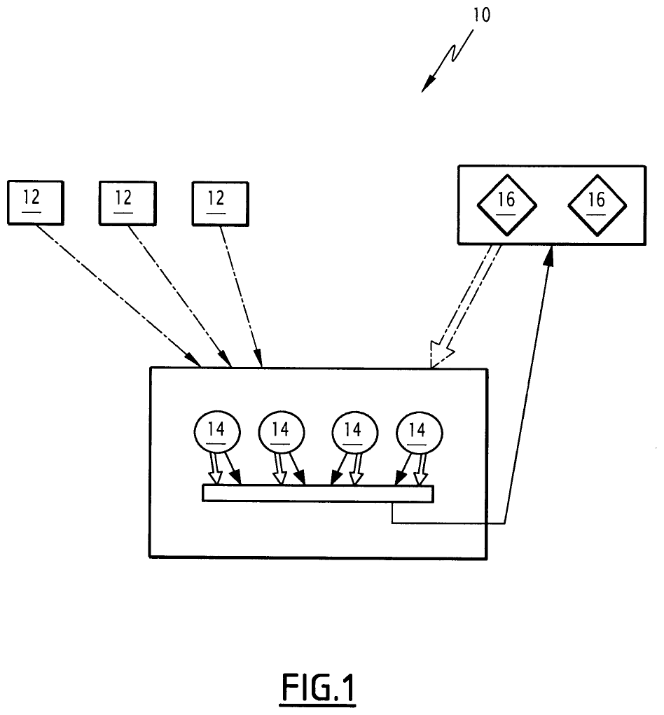

With reference to FIG. 1, a decentralized electronic estimation system 10 is configured to estimate an environmental footprint of a flight of an aircraft. The system 10 comprises at least a first entity 12, a second entity 14 and a third entity 16. In the example shown in FIG. 1, the system 10 comprises three first entities 12, four second entities 14 and two third entities 16.

“Decentralized” means that the entire estimation of the environmental footprint is not carried out by a same electronic device concentrated in only one point of the space. In other words, in the present context, the term “decentralized” is synonymous with the term “distributed”. The above is verified in particular by the fact that the second entities 14 are distinct from the first 12 and third 16 entities.

The first 12, second 14 and third 16 entities are e.g. distributed on Earth as well as in an orbit close to the Earth. Such entities communicate with each other via wired or wireless connections.

The first entities 12, also called oracles, are e.g. sensors integrated in the aircraft or in an environment of the aircraft, apt to acquire measurements during a flight of the aircraft. Oracle refers to an entity apt to supply data.

Environment refers to a volume, with a predefined size, around the aircraft. As an example, an environment of the aircraft is e.g. a volume comprised in a sphere around the aircraft the radius of which is equal to 5 kilometers.

Alternatively, or as an optional supplement, some of the first entities 12 are computers, companies or universities apt to provide measurements relating to the flight of the aircraft. A Pitot tube, a geolocation satellite, an airline, a flight computer, a thermometer, a count of the degree of filling of an aircraft, and a pressure sensor form e.g. a non-exhaustive list of first entities 12. A common point between all the first entities 12 is the ability thereof to supply data, also called measurements, to the second entity (ies) 14.

The second entities 14 are e.g. governmental, intergovernmental or non-governmental authorities related to the field of avionics. For example, the second entities 14 are comprised in a group comprising: The European Aviation Safety Agency (EASA), the Federal Aviation Administration (FAA), the European Organization for the Safety of Air Navigation (EUROCONTROL), the EU emissions Trading System (EU ETS) and the International Civil Aviation Organization (ICAO). As will be described hereinafter, the second entities 14 are configured to evaluate whether the data transmitted by the first entities 12 are plausible by associating a measurement uncertainty with each datum.

The third entities 16, or aggregators, are particular types of oracles.

As will be described hereinafter, the aggregators 16 are configured to process the data of the first entities 12 in order to estimate an environmental indicator representative of the environmental footprint of the flight of the aircraft. For example, the third entities 16 are the FlightFootprint organization, universities, or individuals.

According to one embodiment, at least part of the first entities 12 are also third entities 16. In other words, at least part of the oracles 12 implement the aggregator functions 16.

As an optional complement, the second entities 14 are configured to associate an estimation uncertainty with each environmental indicator, as will be described hereinafter.

Optionally, each of the first 12 and second 14 entities is associated with a credibility value. The credibility value of a respective entity is used to estimate the confidence imparted to said entity in the performance of the task thereof.

Thereby, for each first entity 12, the credibility value is representative of a consistency of the data transmitted by said first entity 12 compared to the other first entities 12. In one example, first entities 12 issue data on the atmospheric temperature in the environment of the aircraft. If the values issued by all but one of the first entities 12 are comprised between −5° C. and 10° C. and one of the first entities 12 issues values comprised between 35° C. and 50° C., the credibility value of the first entity 12 will be lower than the credibility value of the other first entities 12.

For each second entity 14, the credibility value is representative of an objectivity in the association of a measurement uncertainty with each datum. As an example, if one of the second entities 14 associates with a datum, a measurement uncertainty inconsistent with same associated by each other second entity 14, the credibility value of said second entity 14 will be lower than the credibility value of the other second entities 14.

Advantageously, following each contribution of a second entity 14, a bonus or a penalty of the credibility value thereof is granted thereto. Contribution refers to the association of an uncertainty with an environmental datum or indicator.

Optionally, if the credibility value of a second entity 14 is lower than a predefined credibility threshold, said second entity 14 is excluded from the decentralized estimation system 10.

As an optional supplement, each of the third entities 16 is also associated with a credibility value. The credibility value is analogous to the credibility value of the first entities 12 since the aggregators are particular oracles. Thereby, the credibility value of each third entity 16 is representative of a consistency of the environmental indicators estimated by said third entity 16 compared to the other first entities 16.

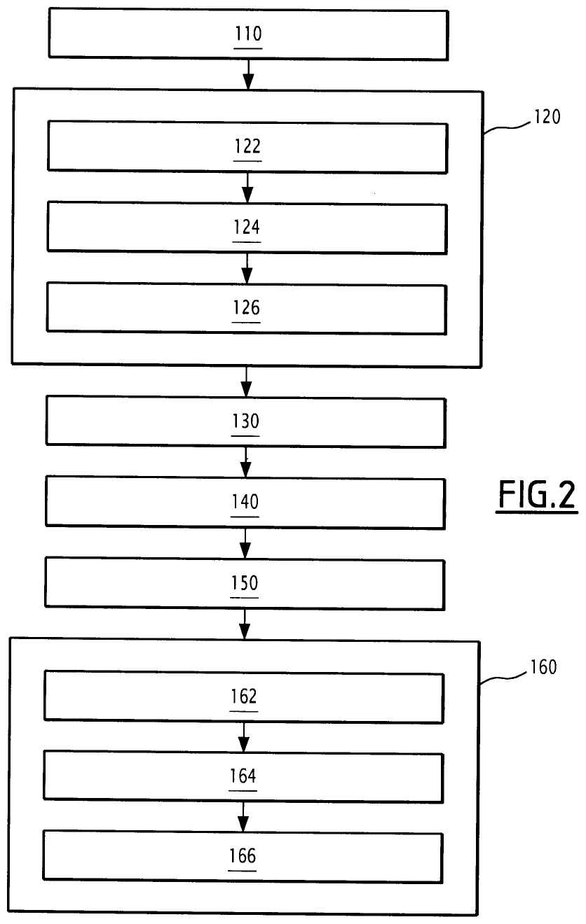

The first 12, second 14 and third 16 entities are configured to communicate with each other in order to implement the estimation method described hereinafter with reference to FIG. 2.

During a first reception step 110, each second entity 14 receives from one of the first entities 12 at least one datum relating to the aircraft or the environment thereof during the flight. In FIG. 1, the reception step 110 is represented by single arrows in dotted lines. As indicated hereinabove, the datum received by each second entity 14 is e.g. a position of the aircraft, a position of other vehicles in the environment of the aircraft, a datum relating to the weather of the environment of the aircraft or a datum relating to intrinsic features of the aircraft. Datum relating to weather refers, but is not limited to, wind speed around the aircraft, information about sunlight around the aircraft, information about the presence of rain in the environment of the aircraft, a pressure around the aircraft or a temperature around the aircraft. A datum relating to intrinsic features of the aircraft refers, but are not limited to, a weights of kerosene on board the aircraft, a weight of the aircraft at take-off, a speed of the aircraft, a temperature in the combustion chamber of the engines of the aircraft, a number of passengers on the aircraft also known as the fill rate, a reference to the model of the aircraft, or the places of departure and of arrival of the aircraft.

Advantageously, the data are accompanied by metadata specifying the context wherein the data were obtained. In other words, when the data are measurements, the metadata indicates e.g. the sampling rate of the sensors that produced the data, a confidence interval on the data obtained by the sensor, and additional information. The additional information is e.g. information about the reference of the sensor used for obtaining the data. If the data are not measurements, but rather values obtained from charts, or statistics produced by the first entities 12, the data advantageously also comprise metadata specifying the context of application of said data. As an example, if the data relate to the number of passengers in a flight of the aircraft, the first entity 12 supplying the data is e.g. the airline having determined an average number of passengers flying on the type of flight considered. The metadata then comprises information on the conditions of application of such averages.

Then, during an association step 120, each second entity 14 associates a measurement uncertainty with the received datum. For this purpose, and as shown in FIG. 1 by solid line single arrows, each second entity 14 assigns an uncertainty score to the datum. The uncertainty score is then specific to each second entity 14. The uncertainty score comprises e.g. two indices serving to evaluate the plausibility of the datum. For example, the uncertainty score comprises a completeness index representative of a uniformity of the data. The completeness index is e.g. related to the sampling rate of the first entity 12. In other words, the completeness index characterizes whether the datum is an isolated datum, potentially less reliable, or whether the datum is part of a regularly acquired data set, potentially more reliable.

The uncertainty score further comprises a confidence index for the measurement of the data. In other words, the confidence index quantifies the quality of the measurement that provided the datum.

For example, a first temperature sensor has a sampling rate of one measurement per hour and an accuracy of one tenth of a degree, and a second temperature sensor has a sampling rate of one measurement per minute and an accuracy of one degree. The data coming from the first sensor will have a lower completeness index than the data coming from the second sensor. However, the confidence index of the data coming from the second sensor will be higher than the confidence index of the data coming from the first sensor.

Optionally, during a first assignment sub-step 122, each second entity 14 thus evaluates the completeness index and the confidence index of the first datum, e.g. by analyzing the metadata of the datum and/or by analyzing a history of data received from the first entity 12 that provided the datum. Indeed, if the first entity 12 at the origin of the data provides a large number of data, the completeness index of the datum will be improved. On the other hand, if the first entity 12 at the origin of the data, provides data more rarely, the completeness index of the datum will be lower because each second entity 14 will be less certain of the plausibility of the datum. Furthermore, if the first datum received is inconsistent with other data previously received, relating to similar phenomena, the confidence index imparted to the last datum received will be reduced as not representative of the phenomenon.

Optionally, during a first determination sub-step 124, the second entities 14 jointly determine the measurement uncertainty of the datum from measurement uncertainty scores assigned by each second entity 14. For this purpose, a predefined rule dictates how the measurement uncertainty is to be determined from the uncertainty scores. As an example, the predefined rule consists in averaging the uncertainty scores given by each second entity 14. Alternatively, the rule consists in determining the measurement uncertainty as being equal to the uncertainty score assigned by the second entity 14 that was the first to assign the uncertainty score thereof. In a variant, the rule consists in averaging the uncertainty scores assigned by each second entity 14, weighted by credibility values of each second entity 14.

Such determination of the measurement uncertainty of the datum is also called consensus since same allows all the second entities 14 to agree on a measurement uncertainty of the datum.

Preferentially, during a first assignment sub-step 126, the second entities 14 assign to the received data, the measurement uncertainty, i.e. the completeness index and the confidence index having reached consensus between the second entities 14.

Following the association step 120, the datum is labeled. In other words, the datum is accompanied by a measurement uncertainty indicating the reliability of the measurement evaluated by the second entities 14.

During a sending step 130, represented in FIG. 1 by a solid line arrow, the second entities 14 send to each third entity 16, the datum and the measurement uncertainty associated with the datum.

During an estimation step 140, each third entity 16 estimates an environmental indicator representative of the environmental footprint of the flight of the aircraft from the data labeled by the second entities 14. The environmental indicator is at least one amongst:
a quantity of carbon dioxide emitted,
a quantity of carbon dioxide equivalent,
a radiative forcing,
a potential of global warming, and
a change in temperature over a predetermined period of time.

During the estimation step 140, the third entities 16 estimate the environmental indicator on the basis of the data labeled by the second entities 14 according to techniques known per se. The environmental indicator estimated by each third entity 16 advantageously comprises metadata including the measurement uncertainties of the data from which said environmental indicator is estimated.

Optionally, during a second reception step 150, each second entity 14 receives from one of the third entities 16, the estimated environmental indicator. Such step is represented in FIG. 1 by a double arrow in dotted lines.

The method then advantageously comprises a second association step 160 during which an estimation uncertainty is associated with the environmental indicator. The implementation of the second association step 160 is substantially similar to the implementation of the first association step 120, except that the second entities 14 associate an estimation uncertainty instead of a measurement uncertainty, the estimation uncertainty being associated with the environmental indicator instead of the datum.

More specifically, the second association step 160 comprises a second assignment sub-step 162 during which each second entity 14 assigns an estimation uncertainty score to the environmental indicator. The estimation uncertainty score comprises an estimation completeness index and an estimation confidence index. The estimation completeness and estimation confidence indices are calculated from the data completeness and confidence indices that were used to obtain the environmental indicator by the third entities 16.

Then, during a second determination sub-step 164, the second entities 14 together determine the estimation uncertainty of the environmental indicator in a way analogous to the determination of the measurement uncertainty carried out during the first determination sub-step 124.

Then, during a second allocation sub-step 166, the second entities 14 allocate the estimation uncertainty to the environmental indicator. Thereby, the environmental indicator is also labeled. The above enables a third party wanting to use said environmental indicator for knowing the reliability of the indicator, via the completeness index thereof and the confidence index thereof.

Thereby, the estimation method according to the invention serves both to estimate the environmental footprint of a flight of an aircraft while plotting the reliability of such estimation. In other words, a third party wanting to use the environmental indicator estimated by the method according to the invention will then also be informed whether the third party can have confidence in the environmental indicator or not.

Furthermore, an objectivity in evaluating uncertainties associated with the estimation of the environmental indicator is ensured by a distinction between the entities 12, 16 providing data or estimating the environmental indicator, and the entities associating a specific uncertainty thereof with such data or environmental indicator. The risk of conflict of interest is then significantly reduced.

Furthermore, if the system 10 comprises credibility values associated with the entities, if a conflict of interest was still noticed, the second entity 14 concerned would then be excluded from the set of second entities 14, in order to restore an objectivity in the uncertainty assessment.

1. A method of estimating an environmental footprint for a flight of an aircraft, the method implemented by a decentralized electronic estimation system comprising a first entity, a second entity and a third entity, the second entity being distinct from the first entity and from the third entity, the method comprising:
receiving, by the second entity, from the first entity, at least one datum relating to the aircraft or the environment thereof during the flight;
associating, by the second entity a measurement uncertainty with each datum received by the second entity;
sending, to the third entity, from the second entity, each datum and the measurement uncertainty associated with the datum; and
estimating, by the third entity, an environmental indicator representative of the environmental footprint, based on at least one datum and the uncertainty associated with the at least one datum.

2. The method according to claim 1, wherein each received datum is a measurement coming from a sensor and is chosen from a group comprising:
a position of the aircraft;
a datum relating to the weather in the environment of the aircraft; and
a datum relating to intrinsic features of the aircraft.

3. The method according to claim 1, wherein the uncertainty associated with each datum received comprises a completeness index representative of a uniformity of the data and an index of confidence in the datum relating to the measurement of the datum.

4. The method according to claim 3, wherein the completeness index and the confidence index of each datum are determined by the second entity, based on a history of data received from the first entity and from the at least one datum.

5. The method according to claim 1, wherein the decentralized electronic estimation system comprises at least two second entities, wherein a credibility value is associated with each of the at least two second entities, and wherein for each second entity, the credibility value is representative of an objectivity in the association of measurement uncertainty with each datum.

6. The method according to claim 5, wherein if the credibility value of one of the second entities is lower than a predefined credibility threshold, the second entity is excluded from the decentralized electronic estimation system.

7. The method according to claim 1, wherein the environmental indicator is chosen from a group comprising:
a quantity of carbon dioxide emitted;
a quantity of carbon dioxide equivalent;
a radiative forcing;
a potential of global warming; and
a change in temperature over a predetermined period of time.

8. The method according to claim 1, wherein the decentralized electronic estimation system comprises at least two second entities, and wherein said associating comprises:
assigning, to the datum by each second entity, a measurement uncertainty score of the datum, each measurement uncertainty score being specific to the second entity;
determining the measurement uncertainty of the datum from the measurement uncertainty scores assigned by the second entities; and
assigning to the datum received, the determined measurement uncertainty.

9. The method according to claim 1, wherein the decentralized electronic estimation system comprises at least two second entities, and wherein the method further comprises, after said estimating:
assigning to the environmental indicator by each second entity, an estimation uncertainty score of the environmental indicator, each estimation uncertainty score being specific to the second entity;
determining an estimation uncertainty of the environmental indicator from the estimation uncertainty scores assigned by each second entity; and
allocating the determined estimation uncertainty to the environmental indicator.

10. A decentralized electronic estimation system comprising:
a first entity;
a second entity receiving from said first entity, at least one datum relating to the aircraft or to the environment thereof during the flight, and associating a measurement uncertainty with each datum received; and
a third entity, wherein the second entity sends each datum and the measurement uncertainty associated with the datum to the third entity, and wherein the third entity estimates an environmental indicator representative of the environmental footprint, based on the at least one datum and the uncertainty associated with the at least one datum, the second entity being distinct from the first entity and from the third entity.

11. The method according to claim 2, wherein the group further comprises a position of other vehicles in the environment of the aircraft.
